(19) United States
(12) Patent Application Publication
(10) Pub. No.: US 2023/0047088 A1
(43) Pub. Date: Feb. 16, 2023

(54) COMBINED SECURITY ACCESS SYSTEM

(71) Applicant: Allthenticate, Inc., Goleta, CA (US)

(72) Inventors: Evan BLASBAND, Goleta, CA (US); Chad Samuel SPENSKY, Goleta, CA (US)

(73) Assignee: Allthenticate, Inc., Goleta, CA (US)

(21) Appl. No.: 17/887,482

(22) Filed: Aug. 14, 2022

Related U.S. Application Data
(60) Provisional application No. 63/233,015, filed on Aug. 13, 2021.

(51) Int. Cl. G07C 9/00; H04L 9/40; H04W 12/63

(52) U.S. Cl. CPC G07C 9/00571; H04L 63/0853; H04L 63/20; H04W 12/63; H04L 9/30

(57) ABSTRACT

A combined security access system for a building that includes a controllable building component. The system includes a combined security access device connected to the building component. The access device further includes: a processor; a first memory device connected to the processor; a second memory device connected to the processor; and a wireless interface module connected to the processor. The access device may be connected to an external electronic device, and the external electronic device communicates with the processor of the access control system to control the building component.

### CROSS-REFERENCE TO RELATED APPLICATION

This application claims the benefit of U.S. Provisional Patent Application No. 63/233,015 filed Aug. 13, 2021, which is incorporated by reference herein in its entirety.

### GENERAL DESCRIPTION

The present application relates to a reader providing access and door security. In particular, the application discloses a combined security access system.

Typical security access devices require users to inconveniently carry multiple access cards which are easily forgotten or lost. Many existing solutions also cannot provide high-security applications due to the fact that the access systems are installed on the outside of the building and cannot receive over-the-air updates. These exterior devices tend to detract from the aesthetics of a building and are vulnerable to physical attacks. Finally, existing systems can only provide as much security as was initially deployed (e.g., a card that is presented) and are not easily upgraded to include more secure forms of identification (e.g., a biometric indicator).

Many conventional security sensing and access devices are small microcontroller-based systems equipped with a short range radio (e.g., 125 Khz or 13.56 Mhz) capable of reading smartcards. These old devices are typically equipped with a symmetric key that can read approved cards and relay the identification information carried on the card to a centralized access-control system. The control system and main controller is typically stored in a locked closet on premises, sometimes hundreds of feet from the access device. The centralized control system provides the command to unlock the door, where the command may be an analog or digital signal. In the event that a user has access, the door the system will actuate a switching device that is typically located on a controller board in the same closet to either provide low voltage electricity (fail secure) or to cut off electrical power (fail safe) to unlock the door. Thus, these existing security sensing devices can only control a limited number of doors each (e.g., up to four doors). An additional device is required for every additional set of doors. Cabling needs to be run from each door to the controller board and from the controller board to back to the lock on the door.

Also, these existing systems can have the following additional issues which limit the ability of the system to function efficiently. The systems do not enable the use of a smartphone and require ethernet connectivity instead of WiFi. The existing systems do not include sensing or access devices that have onboard switching or provide onboard power conversion. All of these systems require major construction to mount a reader or sensing device and to run cables. These existing security sensing systems also typically execute all of the computation and issue the commands at a centralized location, which must be online to function. Thus, these systems require separate boards in-between the reader and the main controller to cache access-control accesses, which increases cost and complexity. Typically, symmetric keys are utilized in these old systems and can be trivially cloned, since the same key is necessarily stored on each unit and, thus, not as secure as possible.

The improved system disclosed herein utilizes a distributed system architecture with cloud technology. The disclosed system utilizes software architecture and control methodology that allows the combined security access system to work with intermittent WiFi access vs. hardwired Ethernet (See U.S. Pat. No. 10,182,040, incorporated by reference herein). This disclosed system allows smartphones to be used to interact with the door using configurable security requirements (e.g., automatic unlock or biometrics). The disclosed system can, for example, turn lights on and off utilizing a software control system. On the other hand, existing systems still require a controller board and various cable runs to interface with smartcards. Furthermore, the disclosed system can also replace the controller board portion of existing systems to maintain the existing functionality (e.g., a smartcard reader or motion sensors).

The disclosed embodiments include improvements to door security access modules and methods of operating the security access modules.

### BRIEF DESCRIPTION OF THE DRAWINGS

The features, aspects, and advantages of the invention will become apparent from the following description, and the accompanying exemplary embodiments shown in the drawings, which are briefly described below.

FIG. 1A is a prior art security access system.

FIG. 1B is an exemplary security access system.

FIG. 2 is a simplified diagram of the exemplary security access system shown in FIG. 1B.

FIG. 3 is a simplified diagram of the exemplary security access system shown in FIG. 1B.

FIG. 4 is a simplified drawings showing an exemplary security access system including a plurality of sensing units.

FIG. 5 is an exploded view of an sensing unit for use with the various embodiments of the security access system described herein.

### DETAILED DESCRIPTION

According to one embodiment of the disclosure, a combined security access device or sensing unit is disclosed herein. The sensing unit includes a processor, a first memory device connected to the processor, a second memory device connected to the processor, a wireless interface module connected to the processor, a first switching device configured to send a first signal and a second switching device configured to send a second signal;

According to another embodiment, a combined security access system for a building is disclosed. The combined security access system includes a combined security access device or sensing unit connected to a building component. The combined security access device further comprises, a processor, a first memory device connected to the processor, a second memory device connected to the processor, a wireless interface module connected to the processor, an external electronic device; and the external electronic device communicates with the processor of the access control system to control the building component.

According to another embodiment a combined security access device or sensing unit is disclosed. The device or unit includes an outer housing including a faceplate and an electrical box, an inner housing having an inner case and a case lid, the inner case fastened to the faceplate and the electrical box, the case lid configured to cover the inner case at one end, and a printed circuit board located within the inner housing.

The system and module includes a smart light switch configured to fit in most standard electrical boxes and has the following capabilities: turn lights on and off using an onboard relay (programatically and by manual actuation like a button), lock and unlock a door using a separate onboard relay (programmatically or by manual actuation like a button, interface with smartphones directly using wireless interfaces (e.g., Bluetooth or WiFi) to control functionality (e.g., locking/unlocking and lights on/off), interface with a cloud network to download access-control policies and authorized public keys, upload logs, and permit remote actuation of the various functionalities (i.e., unlock the door from a website or a smartphone app anywhere). The disclosed invention takes all the necessary requirements to run an access control system and puts them into a singular housing. There are no external power converters needed for the combined security access system, all of the power conversion is done on board within the combined security access device.

The disclosed combined security access device or sensing unit requires no external computing system (e.g., all of the computation is self-contained). The unit has no external switching mechanism (e.g., a relay) because all of the required switching mechanisms (e.g., relays) are included in the unit (e.g., one switching mechanism for a light, another switching mechanism one for the lock, and any other switching mechanism for other applications). The disclosed combined security access device or sensing unit is able to fit inside the wall and inside an electrical box. The unit is able to replace the functionality of a light switch as well as operate as an exit button. The unit is sized to fit in an electrical box for a conventional light switch. As a result, the installation effort is simplified and only includes the connection of a few wires from the light switch to the electronic lock. The functionality of the unit can be modified or expanded extended to support any of the open source smart home standards or to integrate the unit with existing smart home configurations (e.g., SmartThings).

The disclosed combined security system is capable of utilizing smartphones to unlock doors. The disclosed combined security system may also include a motion sensor configured to be used to trigger the unlocking of the door as users approach and turn the light on and off based on motion detection.

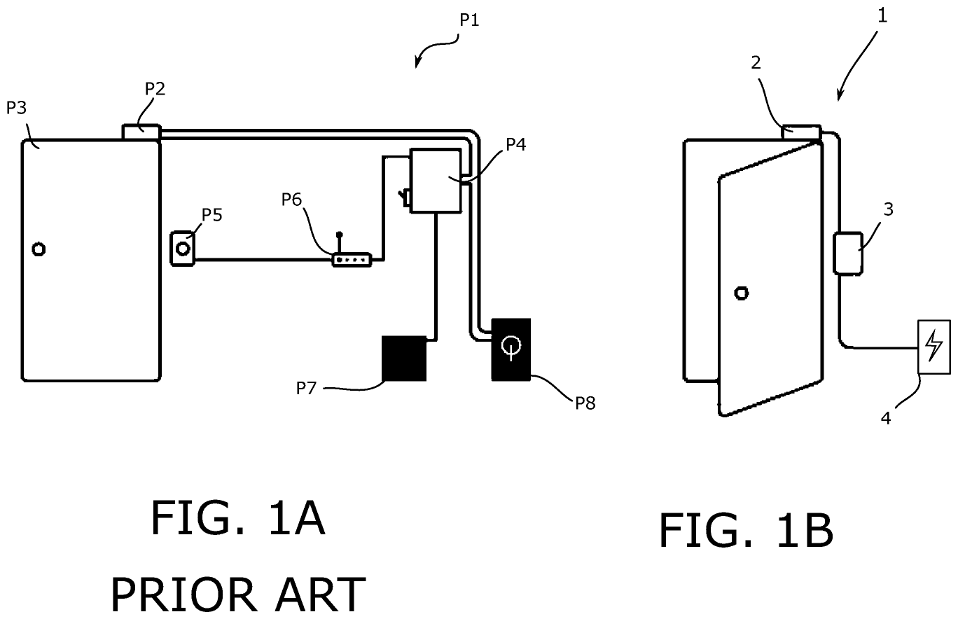

FIG. 1A is a prior art security access system P1. The prior art security access system P1 includes a lock P2 configured to lock the door P3 and is connected to a security access controller P4. The reader P5 is configured to read security cards and is connected to an internet switch P6. The internet switch P6 is configured to also connect to the security access module p4 via ethernet. A power supply P7 for the reader P5 and a power supply P8 for the lock P2 is also configured to be attached to the security access module P4.

FIG. 1B is a combined security access system 1 having a lock 2 and a combined sensing unit or access device 3. The combined sensing unit 3 may be powered by a power source 4, which can be a DC source (e.g. 12V DC) or an AC voltage source (e.g. 110V or 240V AC).

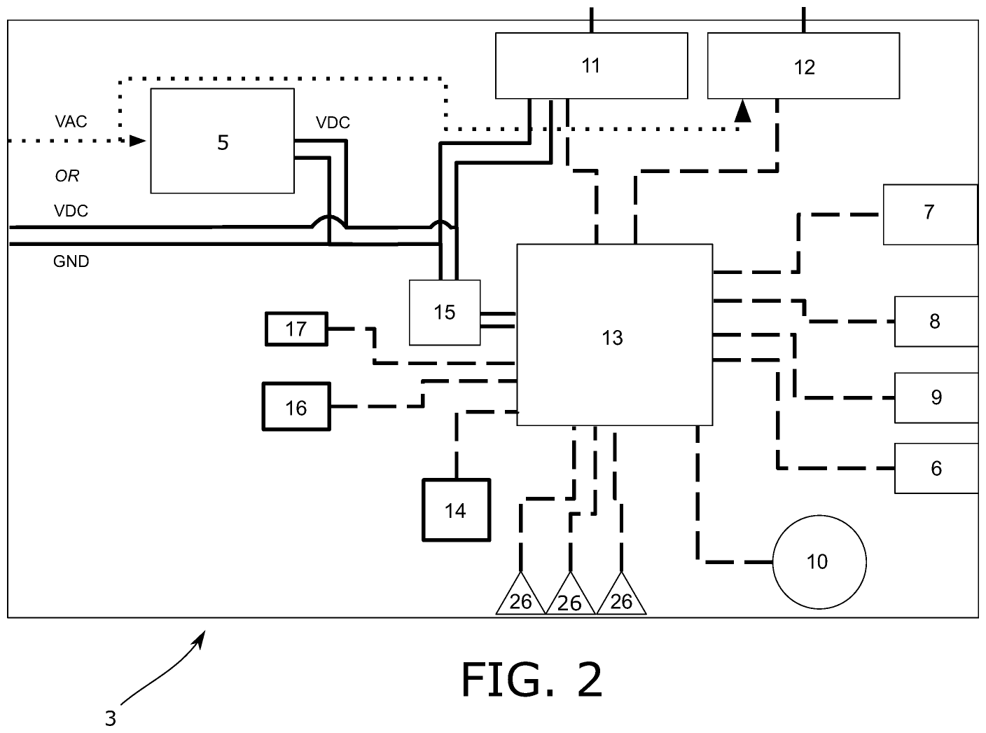

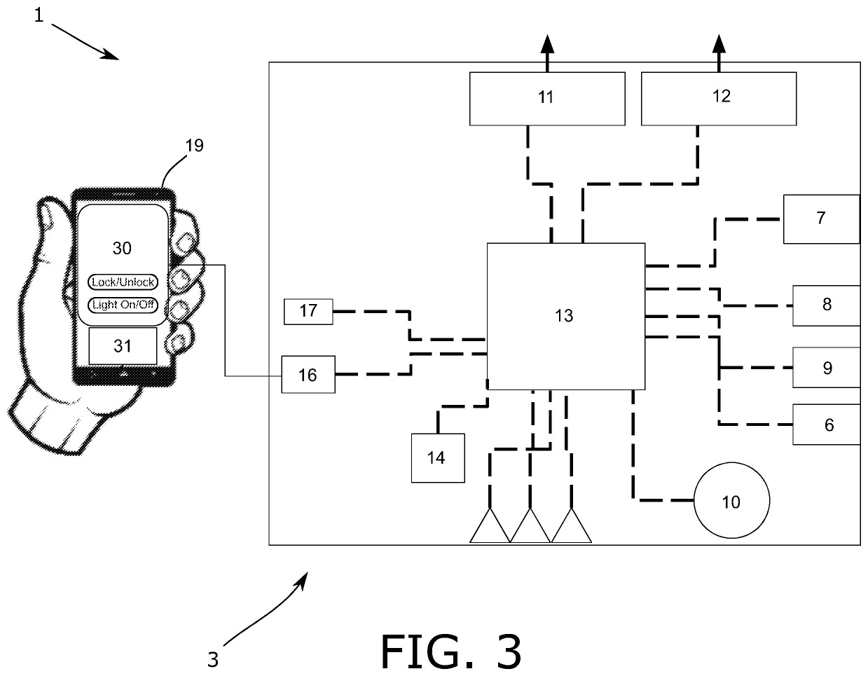

FIGS. 2 and 3 is a simplified schematic drawing showing a portion of the combined sensing unit 3. The combined sensing unit 3 includes an AC-DC converter 5. The combined sensing unit 3 may accept either AC or DC power. AC power can be converted by an onboard AC-DC converter 5. Thus, according to one embodiment DC power can be used to power the required elements in the combined sensing unit 3. In the event that low-voltage DC power is available, the AC-DC converter 5 can be bypassed and the unit can be powered from the DC power directly by connecting the power directly. Thus, the unit is available for use with either an AC or DC power supply without modification. Other modules within the device such as motion sensors 6, legacy smartcard readers (e.g., Wiegand) 7, touch screen 9, other input modules 8 (e.g. radar module, buttons, fire alarm input), LEDs 26, and speakers 10 may be included within the unit 3 and powered accordingly. Other input modules may include a radar-based gesture recognition module which allows authenticated users to control the combined security access device.

The combined sensing unit 3 may also include a first switching module 11 and a second switching module 12. DC Power from the AC-DC converter or a DC power supply may provide power directly to the switching module 11 and power a corresponding device connected to the switching module 11. The first switching module 11 may be connected to a door mechanism such as a door lock or a door actuator. This same DC power may be converted down to a lower voltage (e.g., 5 VDC) for the onboard electronics (e.g., a processor 13 and secure element SE 14) using a DC-DC converter 15. The second switching module 12 may be connected to another external device such as a light switch. Additional switching modules may be implemented to control additional external devices.

The switching module may be configured to actuate the corresponding device the switching modules are connected to. For example, the first switching module 11 connected to the door lock may be configured to lock and unlock the door lock. The switching modules 11 and 12 may be, for example, a transistor or a relay. The switching module actuation logic is implemented in into the input modules (e.g., smart card reader input 7, motion sensors 6, touch screen 8, radar module, buttons, or fire alarm input) to ensure that even if the firmware of the processor 13 is not functioning (e.g. crashed or compromised), the input modules may still actuate the switching modules 11/12. By using specific trusted execution environment (TEE) features or techniques (e.g. TRUST.IO implemented in TrustZone, see IEEE Paper DOI: 10.1109/CNS48642.2020.9162246) the system is able to ensure the security of the interactions even if the firmware is compromised.

The processor 13 is configured to control the switching modules 11 and 12, actuate the onboard speaker 10, and control the onboard LEDS 26 based on software-based logic. The processor 13 may also be configured to receive input signals from the input modules.

The combined sensing unit 3 may further include a wireless connection module 16. The wireless connection module may be a Wi-Fi and/or Bluetooth based module that is configured to communicate with an external device. The wireless connection module 16 may include an antenna in order to communicate with the external device(s).

The device or unit 3 may further include a first memory device 17 that may store a list of public keys of authorized device 19 of authorized users and access policy information. The authorized device 19 may include an application that is configured to control the combined sensing unit 3. The application may include controls 30 which configured to send commands to the combined access module 3 via the wireless module 16. The processor may retrieve the list of public keys of authorized devices of authorized users and access policy information from a cloud network via the wireless connection module 16. The combined sensing unit 3 may continuously attempt to connect to the cloud network via the Wi-Fi connection. When internet connection is achieved via Wi-Fi the sensing unit 3 connects to the cloud network and downloads the access policy information and access control list.

The sensing unit 3 may also constantly receive updated public key lists and may receive commands from the connected cloud network. The access policy information may include different parameters for the sensing unit 3 such as allowed access times. For example, the sensing unit 3 may receive access policy that only allows certain authorized users to pass through a door from 5:30 AM-7 PM, while providing access for another set of authorized users through the same door from 5 PM-11 PM.

The device or unit may also include a second memory device 18. This second memory device 18 may be a secure element (SE) chip to thwart physical attacks. This allows the combined security sensing unit or module survive instances where the central access-control list is inaccessible to ensure permitted users are never “locked out”. This second storage device 18 stores the private key of the combined security access and sensing unit and during authentication the second storage device may also store an authorized device's public key. This private key may be the private half an asymmetric cryptographic key set containing a public key and a private key.

The disclosed combined security door reader (i.e., the access device or sensing unit) may utilize an asymmetric public/private key cryptography. The first storage device 17 is configured to store an “offline” public key list for every device permitted access to the corresponding combined sensing unit 3. The provision of the storage device eliminates the need for the sensing unit 3 to be connected to the internet in order to authorize a user. An authorized device (e.g., a smartphone) of an authorized user may interact directly with the sensing unit 3 over the wireless interface module 16 to cryptographically verify the identity of authorized user using the public key of the sensing unit 3 and the private key of the sensing unit 3. This authorization is performed when the device requests an action. The private key of the sensing unit 3 is stored in the secure second storage device 18 and never leaves the sensing unit 3, thus binding the sensing unit 3 to the specific private key. The authorized device 19 may also include its own computer readable memory 31 that may be a secure element chip configured to store the private key of the authorized device 19.

Authorized devices may connect to the sensing unit 3 using a Bluetooth or Wi-Fi network and mutually authenticate with the sensing unit 3. Both the sensing unit 3 and the authorized device 19 verify each other using private and public keys of the authorized device and the sensing unit 3 as shown in FIG. 3. Once the authenticated connection is made, the authorized device may issue commands (e.g., unlock/lock or turn on/off light), which will be verified with the stored public key in the access-control list in the first storage device 17. The authorized device 19 may send a command signal via the wireless connection module 16 for the processor to actuate the corresponding switching module 11 and/or 12 in order to unlock/lock, turn on/off light or to actuate any connected building component. The building component referred to herein may include an access control panel or gate (e.g., door), lock, light and/or lighting system, power switch or breaker; alarm, environmental control component or system (e.g., HVAC system). The connection to the building component may be a direct or indirect connection. For example, the connection may be direct wired, wireless, bluetooth, physically attached or other suitable arrangement.

Corresponding LED's 26 may also be actuated by the processor to show the status of the corresponding switching module to show whether the lights are on/off or whether the door has been locked or unlocked. For added security, this can be done using Trusted Execution Environment (TEE) features or techniques (e.g., Trust.IO implemented in TrustZone). These authenticated commands may also be issued remotely using the Wi-Fi connection via the wireless connection module 16 through the cloud network from any authenticated devices. Input modules may be utilized in order to activate the switching modules 11 and 12 once the device has been authenticated. Motion sensors 6 may be trigged automatically upon proximity movement of an authorized user to either unlock the door or turn on the light. A touch screen 8 may also include a UI to actuate different building components such as the doors and lights. The touch screen 8 may also be any input/output (I/O) device that allows the user to interact with and receive output from the device 3. The smartcard input module 7 may also be utilized to unlock doors or switching the lights after authentication to allow additional layer of security. Similarly, radar based gestures may be used via other input modules 8. The acoustic device 10 may be a speaker system that allows audio confirmation of certain actions such as locking and unlocking doors and turning on and off lights. The combined sensing unit 3 may also be connected to the fire alarm system of the building. This connection would allow doors to unlock in emergency situations.

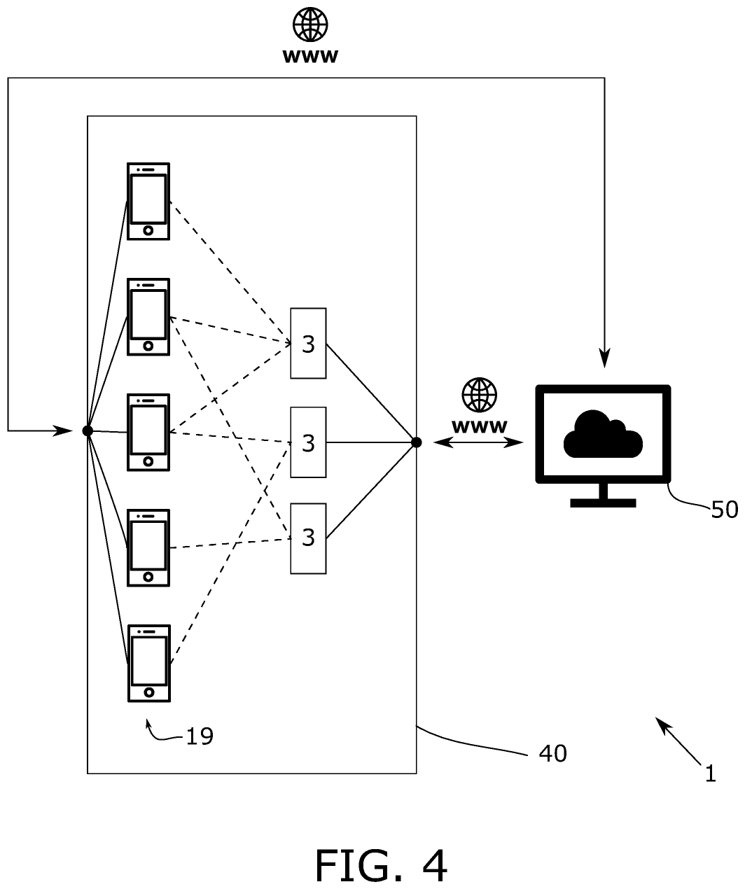

FIG. 4 shows the connection within the combined security access system 1. The combined security sensing units 3 of the building 40 are connected to one or more authorized devices 19. The sensing devices 3 will connect to the cloud network 50 via the internet. The cloud network 50 may send or receive data from the sensing devices 3. The cloud network 50 allows the sensing devices 3 to download access-control policies and authorized public keys from the cloud network 50, upload logs to the cloud network, and permit remote actuation of various functionalities via the cloud network.

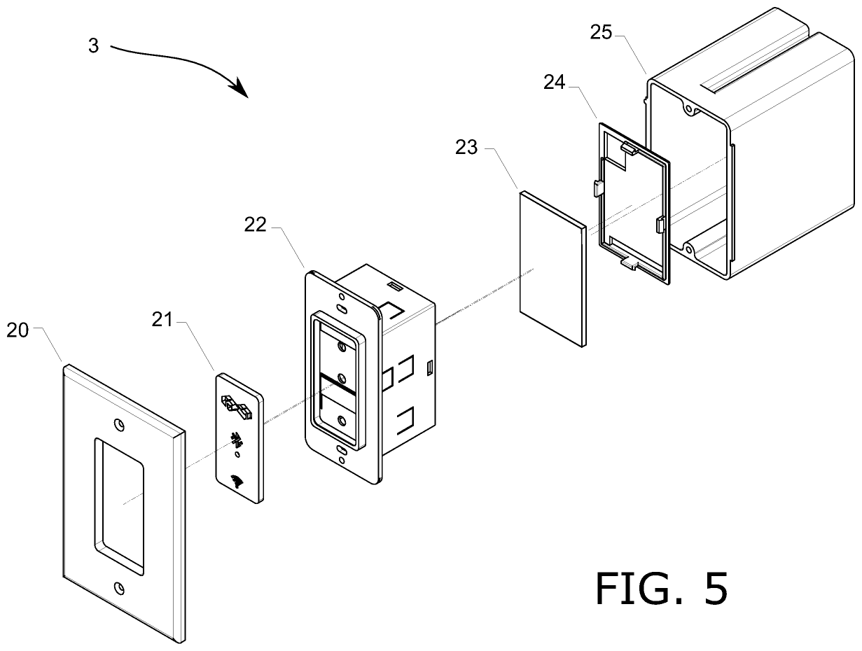

FIG. 5 is an exploded view of the combined sensing unit 3. The combined security access device and sensing unit includes a face plate 20, an acrylic plate 21, a case 22, a combined PCB 23, case lid 24, and an electrical box 25. The case lid, acrylic plate, electrical box, and faceplate are configured to house the smart card reader case, combined PCB 23. The combined PCB 23 may include one or more PCB's combined or attached together. The acrylic plate may provide a visible display for corresponding LEDS of the status of certain modules or components of the security sensing unit 3. The face plate 20 is configured to be fastened onto the electrical box 25 and the case via fasteners (not shown). The acrylic plate 21 is configured to be placed in front of the case 22. The combined PCB 23 is configured to be housed within the case 22 and the case 22 is configured to be closed via the case lid 24. The case is configured to also be fastened onto the electrical box 25 via the fasteners. The case is housed within the face plate 20 and electrical box 25.

Certain advantages of the disclosed system and device are described below. The combined security access device may be installed in most standard electrical boxes made for light switches. The combined security access device has all necessary components to be a self-contained access-control solution and requires no additional systems, whereas other systems require a product to read data, a product to operate on the data that has been read, and a separate product to power and switch the various components. The combined security access device is capable of being connected straight into the main AC power lines and may convert the power on board whereas other systems require external power conversion. The combined security access device fits inside the wall and inside a standard electrical box as well as on the inside of the door whereas other solutions are placed on the exterior of the wall as well as the exterior of the door. The combined security access device performs all the data reading and computation fully self-contained whereas other solutions read and compute data using separate products.

Several additional advantages of the system and device are described below. For example, the combined security access device may replace a standard light switch allowing the combined security access system to control lights as well as access control whereas other solutions are not capably of operating or controlling the lights or other external devices at the same time. The combined security access device may interface with any wireless device. The combined security access device has a configurable interface (e.g., Wiegand) and can act as the controller board and switching device for legacy smartcard systems. The combined security access system may be configured to receive continuous over-the-air updates to increase functionality and fix security issues. The combined security access system does not require continuous access to the centralized access-control system to function. The module only needs intermittent access to update the policies, which are stored locally. The combined security access system discloses herein has the capability to provide for significantly faster, simpler, and cheaper installation of an access control solution while also allowing the ability to use a smartphone to unlock a door.

Even more advantages of the system and device are described below. For example, the combined security access system enables a more flexible access-control interface by allowing customers to leverage the sensors on their smartphones instead of needing specialized hardware. For example, FaceID(c), fingerprint sensors, PIN and password entry systems, and other authentication methods may be utilized. The combined security access system thwarts physical attacks by being installed in the interior of the building. The system makes the office space look cleaner, by blending into the existing light-switch box. The combined security access system is completely backward compatible with existing (e.g., Wiegand-based) smartcard readers using a software-configurable hardware interface to support legacy interactions as well as smartphone-based access control. The combined security access system is easily configured by a cloud-based interface, which removes the hosting burden from users. The combined security access system access system is able to operate with existing Wi-Fi networks and is not negatively impacted by intermittent Internet access.

The potential applications of the system described herein include most commercial and residential applications that require access control. The combined security access system is able to significantly reduce the number of components required to outfit a door with an access-control solution by embedding the power converter, switching mechanisms, exit buttons and motion sensors, and wireless radios. The combined security access system is capable of significantly reducing the cost of goods sold when producing an access control solution. Since everything is self-contained a single manufacturer can produce the entire unit. The combined security access system increases the user experience by allowing them to use their smartphone and existing smartcards to open doors. This includes setting schedules to automatically lock or unlock and turn the light on and off

As utilized herein, the terms “approximately,” “about,” “substantially”, and similar terms are intended to have a broad meaning in harmony with the common and accepted usage by those of ordinary skill in the art of automotive safety devices. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the module and system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed:

1. A combined security access device comprising:
a processor;
a first memory device connected to the processor;
a second memory device connected to the processor;
a wireless interface module connected to the processor;
a first switching device configured to send a first signal; and
a second switching device configured to send a second signal.

2. The combined security access device of claim 1, further comprising an input module for a smart card, wherein data from a smartcard is configured to actuate at least one of the first switching device and the second switching device.

3. The combined security access device of claim 1, further comprising a touch screen configured to actuate at least one of the first switching device and the second switching device.

4. The combined security access device of claim 1, further comprising a motion sensor, wherein the motion sensor is configured to actuate at least one of the first switching device and the second switching device.

5. The combined security access device of claim 1, further comprising a radar gesture module, wherein the radar gesture module is configured to actuate at least one of the first switching device and the second switching device.

6. The combined security access device of claim 1, wherein the first signal is configured to actuate door locks.

7. The combined security access device of claim 1, wherein the second signal is configured to actuate lights.

8. The combined security access device of claim 6, further comprising an AC to DC converter configured to supply power to the door lock and the processor.

9. The combined security access device of claim 8, further comprising a DC to DC converter configured to receive the power supplied by the AC to DC converter at a first voltage and wherein the DC to DC converter is configured to change the first voltage of the received power supplied by the AC to DC converter to a second voltage and supply the processor with power at the second voltage

10. A combined security access system for a building that includes a controllable building component, the combined security access system comprising:
a combined security access device connected to the building component;
wherein the combined security access device further comprises:
a processor;
a first memory device connected to the processor;
a second memory device connected to the processor;
a wireless interface module connected to the processor;
an external electronic device; and
wherein the external electronic device communicates with the processor of the access control system to control the building component.

11. The combined security access system of claim 10, wherein the first memory device stores a list of public keys and access policy information connected to the processor.

12. The combined security access system of claim 11, wherein the second memory device stores a private key of the combined security access device.

13. The combined security access system of claim 12, wherein the external electronic device is an electronic mobile device configured to communicate with the wireless interface module.

14. The combined security access system of claim 13, wherein the electronic mobile device is configured to be authenticated by the combined security access device via a public key of the combined security access device, wherein the key is stored in a memory device of the electronic mobile device and the private key of the combined security access device is stored in the second memory device.

15. The combined security access system of claim 14, wherein the combined security access device is configured to be authenticated by the electronic mobile device via a public key of the electronic mobile device, and wherein the public key is stored in the list of public keys and a private key of the electronic mobile device is stored in the memory device of the electronic mobile device.

16. The combined security access system of claim 10, wherein the combined security access device is configured to be located within a light switch housing of the building.

17. A combined security access device comprising:
an outer housing including a faceplate and an electrical box;
an inner housing having an inner case and a case lid;
the inner case fastened to the faceplate and the electrical box;
the case lid configured to cover the inner case at one end; and
a printed circuit board located within the inner housing.

18. The combined security access device of claim 16, further comprising an acrylic case configured to be attached to the inner case and located within an opening of the face plate.

19. The combined security access device of claim 16, further comprising a fastener configured to fasten the faceplate the inner case, and the electrical box together.

20. The combined security access device of claim 16, wherein the inner housing is located within the outer housing.
